(19) United States
(12) Patent Application Publication
(10) Pub. No.: US 2015/0089669 A1
(43) Pub. Date: Mar. 26, 2015

(54) CONTENT PROVISION DEVICE, CONTENT PROVISION METHOD, PROGRAM, AND RECORDING MEDIUM

(71) Applicant: Rakuten, Inc., Tokyo (JP)

(72) Inventor: Hisashi Suzuki, Shinagawa-ku (JP)

(73) Assignee: Rakuten, Inc., Tokyo (JP)

(21) Appl. No.: 14/397,222

(22) PCT Filed: Nov. 12, 2012
(86) PCT No.: PCT/JP2012/079246

§ 371 Date: Oct. 27, 2014

(30) Foreign Application Priority Data
Apr. 27, 2012 (JP) 2012-104189

(51) Int. Cl. G06F 21/10; H04L 29/06; G06Q 20/12

(52) U.S. Cl. CPC G06F 21/105; G06Q 20/1235; H04L 63/102; G06F 2221/2101
USPC 726/28

(57) ABSTRACT

Content suitable for a user is provided to an information processing terminal that is confirmed to be used by the user. An accepting unit accepts an access from a user terminal. A determining unit determines whether or not to provide the user terminal with the content suitable for the user based on a length of a period from a previous access to this access of the user terminal. A processing execution unit executes processing for providing the user terminal with the content in a case where it is determined to provide the user terminal with the content suitable for the user.

### TECHNICAL FIELD

The present invention relates to a content providing device, a content providing method, a program, and a storage medium.

### BACKGROUND ART

There exist information processing terminals for viewing and reproducing digital content such as an electronic book. Regarding such information processing terminals, patent literature 1 discloses a terminal in which a plurality of pieces of content are pre-installed so as to be provided to a user.

### CITATION LIST

### Patent Literature

Patent Literature 1: JP2006-24030A

### SUMMARY OF INVENTION

### Technical Problem

Preferences of digital content may differ with each user. However, pre-installed content in an information processing terminal is standardized regardless of a preference of a user, and thus the content that does not fit the user's preference could be included in the pre-installed content.

In addition, in a case where it takes a longer time for a user to start using an information processing terminal after content is pre-installed in the terminal, for the reason that, for example, the content is pre-installed in the information processing terminal at the time when the terminal is manufactured, the pre-installed content could become outdated. As a result, the likelihood that the pre-installed content does not fit the user's preference is increased.

Further, if an amount of content pre-installed in the information processing terminal is large, the storage capacity of the information processing terminal could become insufficient because of the content that does not fit the user's preference.

Moreover, some of the users who receive an information processing terminal as a present do not use the information processing terminal because, for example, they do not know how to use the information processing terminal. In such a case, the content pre-installed in the information processing terminals will be totally wasted.

For a provider of the content, it is necessary to manage the content regardless of whether or not the user uses the content. In addition, depending on types of content, pre-installing the content may incur a copyright fee.

In view of the above, it is apparently desirable that the content suitable for a user is provided to an information processing terminal that is confirmed to be used by the user.

One or more embodiments of the present invention have been conceived in view of the above, and an object thereof is to provide content suitable for a user to an information processing terminal that is confirmed to be used by the user.

### Solution to Problem

In order to solve the above-mentioned problem, a content providing device according to the present invention includes accepting means for accepting an access from an information processing terminal of a user, determining means for determining whether or not to provide the information processing terminal with content suitable for the user based on a length of a period from a previous access of the information processing terminal of the user to this access of the information processing terminal of the user, and processing execution means for executing, in a case where it is determined to provide the information processing terminal with the content suitable for the user, processing for providing the information processing terminal with the content.

A content providing method according to the present invention includes the steps of accepting an access from an information processing terminal of a user, determining whether or not to provide the information processing terminal with content suitable for the user based on a length of a period from a previous access of the information processing terminal of the user to this access of the information processing terminal of the user, and executing, in a case where it is determined to provide the information processing terminal with the content suitable for the user, processing for providing the information processing terminal with the content.

A program according to the present invention for causing a computer to function as accepting means for accepting an access from an information processing terminal of a user, determining means for determining whether or not to provide the information processing terminal with content suitable for the user based on a length of a period from a previous access of the information processing terminal of the user to this access of the information processing terminal of the user, and processing execution means for executing, in a case where it is determined to provide the information processing terminal with the content suitable for the user, processing for providing the information processing terminal with the content.

A storage medium according to the present invention stores a program for causing a computer to function as accepting means for accepting an access from an information processing terminal of a user, determining means for determining whether or not to provide the information processing terminal with content suitable for the user based on a length of a period from a previous access of the information processing terminal of the user to this access of the information processing terminal of the user, and processing execution means for executing, in a case where it is determined to provide the information processing terminal with the content suitable for the user, processing for providing the information processing terminal with the content.

Another content providing device according to the present invention includes accepting means for accepting an access from an information processing terminal of a user, determining means for determining to provide the information processing terminal with content suitable for the user in a case where the access is an access relating to processing for activating the information processing terminal, and processing execution means for executing, in a case where it is determined to provide the information processing terminal with the content suitable for the user, the processing for activating the information processing terminal and processing for providing the information processing terminal of the user with the content suitable for the user.

Another content providing method according to the present invention includes accepting an access from an information processing terminal of a user, determining to provide the information processing terminal with content suitable for the user in a case where the access is an access relating to processing for activating the information processing terminal, and executing, in a case where it is determined to provide the information processing terminal with the content suitable for the user, the processing for activating the information processing terminal and processing for providing the information processing terminal of the user with the content suitable for the user.

Another program according to the present invention causes a computer to function as accepting means for accepting an access from an information processing terminal of a user, determining means for determining to provide the information processing terminal with content suitable for the user in a case where the access is an access relating to processing for activating the information processing terminal, and processing execution means for executing, in a case where it is determined to provide the information processing terminal with the content suitable for the user, the processing for activating the information processing terminal and processing for providing the information processing terminal of the user with the content suitable for the user.

Another storage medium according to the present invention stores a program for causing a computer to function as accepting means for accepting an access from an information processing terminal of a user, determining means for determining to provide the information processing terminal with content suitable for the user in a case where the access is an access relating to processing for activating the information processing terminal, and processing execution means for executing, in a case where it is determined to provide the information processing terminal with the content suitable for the user, the processing for activating the information processing terminal and processing for providing the information processing terminal of the user with the content suitable for the user.

According to the present invention, content suitable for a user is provided to an information processing terminal that is confirmed to be used by the user.

In one embodiment of the present invention, the determining means determines to provide the information processing terminal with the content suitable for the user in a case where an access accepted from the information processing terminal is a first access, and, in a case where it is determined to provide the information processing terminal with the content suitable for the user, the processing execution means executes processing for activating the information processing terminal and processing for providing the information processing terminal with the content suitable for the user.

Further, in one embodiment of the present invention, the accepting means receives payment information necessary for payment of the content, and the processing execution means executes the processing for activating the information processing terminal with use of the payment information, and processing for providing the information processing terminal with the content corresponding to usage history of a shopping system, in which information of the user who is specified based on the payment information is registered, or usage history of the content providing device by the user.

Further, in one embodiment of the present invention, the determining means determines to provide the information processing terminal with the content suitable for the user in a case where the access is an access for requesting to update an operating system installed in the information processing terminal, and, in a case where it is determined to provide the information processing terminal with the content suitable for the user, the processing execution means executes processing for updating the operating system installed in the information processing terminal and processing for providing the information processing terminal with the content suitable for the user.

Further, in one embodiment of the present invention, the determining means determines to provide the information processing terminal with the content suitable for the user in a case where the length of the period from the previous access of the information processing terminal of the user to this access of the information processing terminal of the user exceeds a predetermined length.

Further, in one embodiment of the present invention, the processing execution means executes the processing for providing the information processing terminal with the content in a state in which viewing of at least a part of the content is restricted before payment processing of the content is executed, and viewing of the at least a part of the content is allowed after the payment processing of the content is executed.

Further, in one embodiment of the present invention, the determining means determines whether or not to provide the content based on an unused capacity of a storage unit provided to the information processing terminal.

Further, in one embodiment of the present invention, the determining means determines not to provide the content to the information processing terminal in a case where communication between the content providing device and the information processing terminal or the content to be provided to the information processing terminal is charged on an as-used basis.

### BRIEF DESCRIPTION OF DRAWINGS

FIG. 1 A diagram illustrating an overall configuration of a shopping system according to an embodiment of the present invention.

FIG. 2 A diagram illustrating an example of a data structure of electronic book management data.

FIG. 3 A diagram illustrating an example of a data structure of account data.

FIG. 4 A functional block diagram illustrating an example of functions implemented by a shopping server according to the embodiment.

FIG. 5 A flow chart illustrating an example of a flow of processing performed by the shopping system according to the embodiment of the present invention.

FIG. 6 A diagram illustrating an example of an activation screen.

### DESCRIPTION OF EMBODIMENTS

An embodiment of the present invention will be described below in detail with reference to the accompanying drawings.

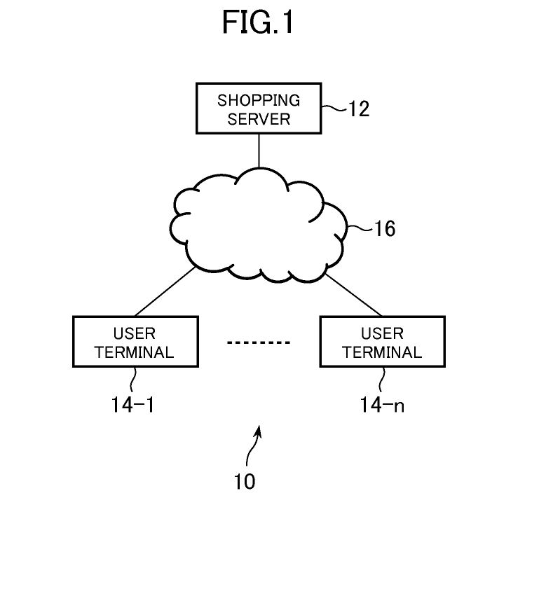

FIG. 1 is a diagram illustrating the overall configuration of a shopping system 10 according to an embodiment of the present invention. As shown in FIG. 1, the shopping system 10 of this embodiment includes a shopping server 12 and user terminals 14 (14-1-14-n), each of which is mainly configured with a computer. The shopping server 12 and the user terminals 14 are connected to a computer network 16, such as the Internet, and able to communicate with each other.

The shopping server 12 is a computer, such as a web server, for performing processing relating to e-commerce in which, using the web technology, information on goods or services is provided to users and payment of the goods or service is made in response to purchase requests from the users.

The shopping server 12 according to this embodiment also has a role as a content providing device in this embodiment, and provides a service of sending electronic books stored in the shopping server 12 to the user terminals 14 using web technology. The shopping server 12 includes, for example, a control unit, a storage unit, and a communication unit. The control unit is, for example, a program controlling device such as a CPU configured to operate in accordance with a program installed in the shopping server 12. The storage unit is, for example, a memory device such as a ROM and a RAM or a hard disk drive. The communication unit is, for example, a communication interface such as a network board. Those components are connected to one another through a bus. The storage unit of the shopping server 12 stores the program executed by the control unit of the shopping server 12. The storage unit of the shopping server 12 operates as a work memory of the shopping server 12. The user terminal 14 is a computer used by a user of the shopping system 10 and is, for example, a personal computer, a tablet-type terminal, a smartphone, and a mobile phone. The user terminal 14 includes, for example, a control unit such as a CPU, a storage unit such as a memory device, for example, a ROM and a RAM, and a hard disk drive, a display unit such as a display, an input unit such as a mouse, a keyboard, a touch panel, and a button, and a communication unit such as a network board. A Web browser is installed in advance in the user terminal 14 according to this embodiment, and a program of the Web browser is executed. The user terminal 14 receives various services provided by the shopping server 12 through the web browser.

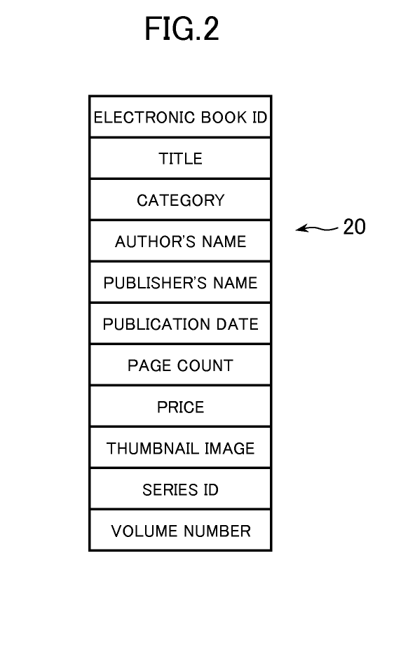

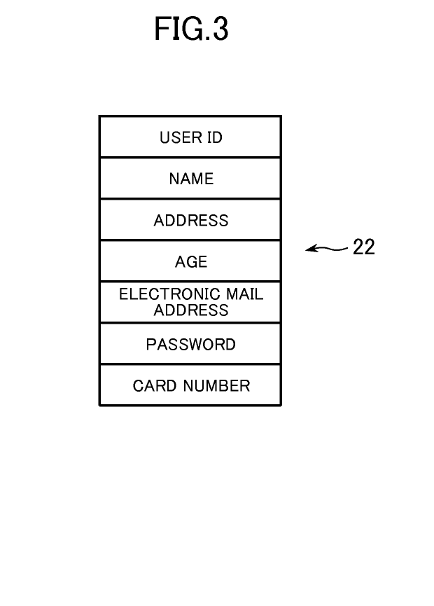

In this embodiment, the storage unit of the shopping server 12 stores in advance a plurality of electronic books, electronic book management data 20 (see FIG. 2) for managing bibliographic items or the like on the electronic book, account data 22 (see FIG. 3) for managing an account of a user of the shopping system 10. In this embodiment, the storage unit of the shopping server 12 stores in advance the file of the electronic book.

FIG. 2 shows an example of a data structure of the electronic book management data 20. As shown in FIG. 2, the electronic book management data 20 includes, for example, an electronic book ID serving as an identifier of the electronic book, a title, a category, an author's name, a publisher's name, a publication date, a page count, a price, and a thumbnail image. Specific examples of the electronic book ID include an international standard book number (ISBN). Examples of the category include mystery, fantasy, and nonfiction. In regard to electronic books formed of a plurality of volumes, the electronic book management data 20 also includes, for example, a series ID for identifying an electronic book group formed of a plurality of volumes and a volume number. In this embodiment, for example, a value of the same series ID is set for the electronic books belonging to a given electronic book group.

FIG. 3 shows an example of a data structure of the account data 22. As shown in FIG. 3, the account data 22 includes a user ID, a name, an address, an age, an electronic mail address, a password for authenticating the user, and a card number. The user ID is, for example, information for identifying the user who uses the shopping system 10. The card number is, for example, a number of a credit card to be used by a user for the payment of goods or services in the shopping system 10.

The storage unit of the shopping server 12 also stores, as the account data 22, a purchase history of the goods or services purchased using the shopping server 12 by the user who has a registered account, and a browsing history of web pages provided by the shopping server 12.

In this embodiment, when the user terminal 14 accesses the shopping server 12 via a web browser, inputs the user ID and the password, and then accesses a predetermined URL, a page corresponding to the predetermined URL is displayed on a display of the user terminal 14. Note that, after the user ID and the password are input, the shopping server 12 can identify the user ID of the user who uses the user terminal 14 by, for example, referring to session information.

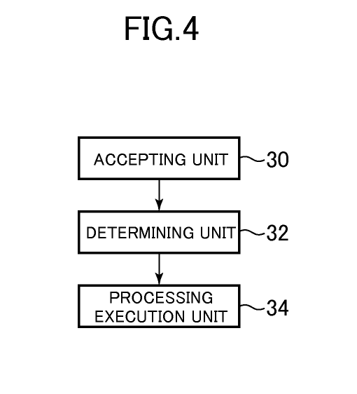

FIG. 4 is a functional block diagram illustrating an example of functions implemented by the shopping server 12 according to this embodiment. Note that, in the shopping server 12 according to this embodiment, functions other than the functions illustrated in FIG. 4 are also implemented.

The shopping server 12 according to this embodiment functionally includes an accepting unit 30, a determining unit 32, and a processing execution unit 34. Those components are implemented by executing the programs installed in the shopping server 12, which is a computer, by the control unit of the shopping server 12. The programs are supplied to the shopping server 12 via, for example, a computer-readable recording medium such as a CD-ROM and a DVD-ROM, or via a communication network such as the Internet. Receiving means disclosed in Claims corresponds to the accepting unit 30 in this embodiment. Determining means disclosed in Claims corresponds to the determining unit 32 in this embodiment. Processing execution means disclosed in Claims corresponds to the processing execution unit 34 in this embodiment.

In the shopping system 10 according to this embodiment, when the user whose account data 22 is previously registered supplies power to a new user terminal 14 at the first time of use, the user terminal 14 starts up itself. Subsequently, when activation processing of the user terminal 14 is finished, services provided by the shopping server 12 are available on the user terminal 14. In this embodiment, while the activation processing is performed, the shopping server 12 sends to the user terminal 14, which is the target of the activation processing, an electronic book suitable for the user of the user terminal 14. In the following, the electronic book suitable for the user of the user terminal 14 is referred to as a recommended electronic book.

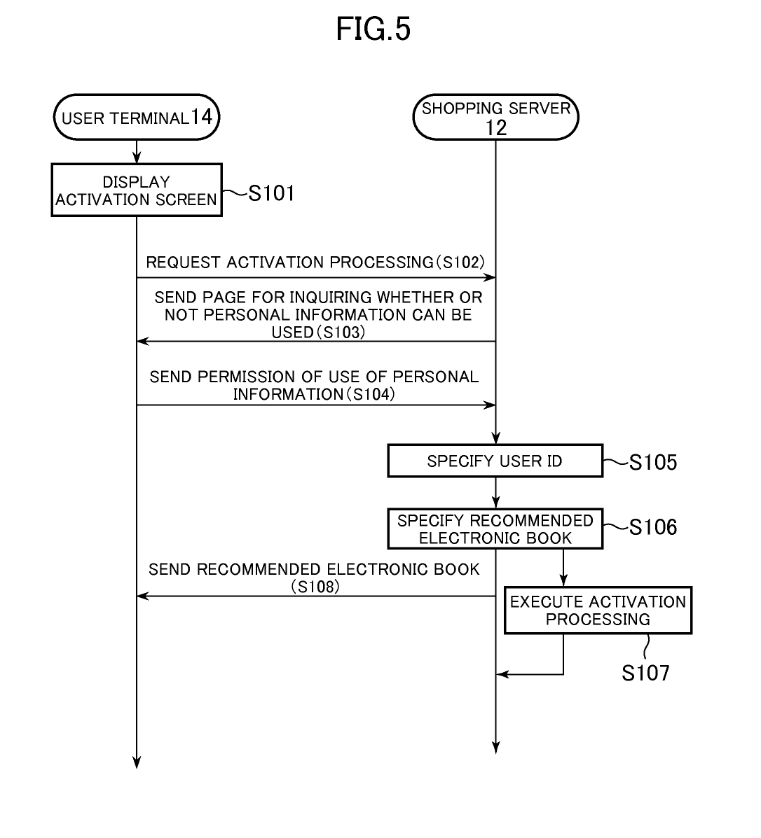

Here, an example of a flow of processing performed by the shopping system 10 according to this embodiment is described with reference to a flowchart illustrated in FIG. 5.

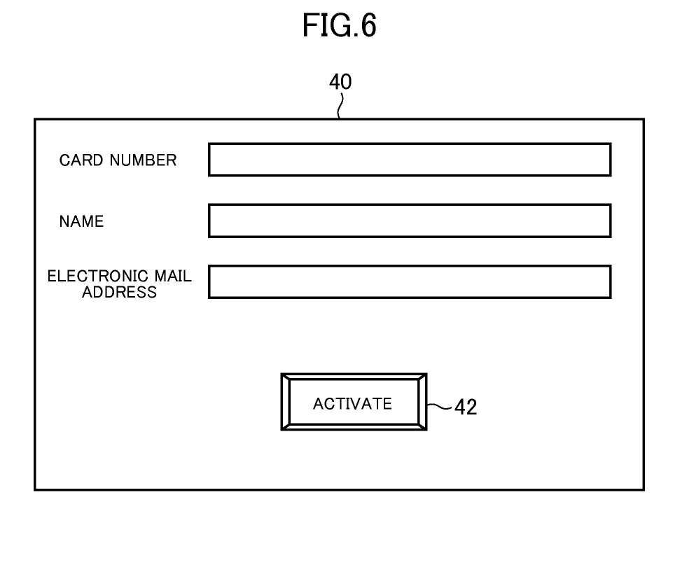

First, when the user whose account data 22 is previously registered in the storage unit of the shopping server 12 supplies power to the user terminal 14 in which the activation processing should be performed, that is, the user terminal 14 that the user newly starts to use, the user terminal 14 starts up itself. Then, the user terminal 14 shows an activation screen 40 illustrated in FIG. 6 on a display (S101).

As shown in FIG. 6, the activation screen 40 includes fields to which information necessary for the payment of the electronic book provided by the shopping server 12 is entered. In the following, the information necessary for the payment of the electronic book is referred to as payment information. In this embodiment, the activation screen 40 includes fields for a card number of a credit card to be used for the payment of the electronic book, and a user′ name and electronic mail address, for example. In addition, the activation screen 40 includes an activation button 42 for executing the activation processing.

Here, the user enters the card number, user's name, and electronic mail address in the fields on the activation screen 40, and clicks on the activation button 42. Subsequently, the user terminal 14 sends to the shopping server 12 a request for the activation processing associated with the entered card number, user's name, and electronic mail address. The accepting unit 30 of the shopping server 12 receives the request for the activation processing (S102).

The processing execution unit 34 sends, to the user terminal 14, a page (not shown) for inquiring about whether or not an operator of the shopping server 12 can use personal information of the user in order to specify the recommended electronic book for the user. The user terminal 14 then receives the page (S103). The page includes a permission button that is clicked when the user of the user terminal 14 permits the operator of the shopping server 12 to use the personal information of the user in order to specify the recommended electronic book for the user.

When the user clicks on the permission button, the user terminal 14 sends, to the shopping server 12, information that use of the personal information is permitted. Subsequently, the accepting unit 30 of the shopping server 12 receives the information that use of the personal information is permitted (S104).

In the account data 22, the determining unit 32 specifies the user ID that is associated with the card number received in the processing in S102 (S105).

Based on the user ID specified in S105, the determining unit specifies the recommended electronic book for the user corresponding to the user ID (S106).

In this embodiment, for example, in S106, the determining unit 32 specifies the recommended electronic book for the user based on the usage history of the shopping server 12 by the user corresponding to the user ID specified in S105. Specifically, for example, the determining unit 32 may specify the recommended electronic book for the user based on the purchase history of the electronic books purchased by the user corresponding to the user ID specified in S105. Further, for example, the determining unit 32 may specify the recommended electronic book for the user based on the purchase history of the electronic books that the user has purchased using another user terminal 14 by accessing the shopping server 12. Further, for example, the determining unit 32 may specify the recommended electronic book for the user based on the purchase history of paper books or goods or services, which do not include electronic books, purchased through the shopping server 12 by the user corresponding to the user ID specified in S105.

For example, an electronic book having the same author as that of any of the purchased electronic books may be specified as the recommended electronic book. For example, an electronic book categorized into the same type as that of any of the purchased electronic books may be specified as the recommended electronic book. For example, an electronic book having the same publisher as that of any of the purchased electronic books may be specified as the recommended electronic book. For example, an electronic book published in the same year as that of any of the purchased electronic books may be specified as the recommended electronic book. For example, when the title of the electronic book partially includes the name of the purchased goods or services, such electronic book may be specified as the recommended electronic book.

The determining unit 32 may specify the recommended electronic book for the user based on the usage history of the shopping server 12 other than mentioned above. For example, the determining unit 32 may specify the recommended electronic book for the user based on the browsing history of the pages provided by the shopping server 12. Further, the determining unit 32 may specify the recommended electronic book for the user based on, for example, the goods or services that user has bookmarked in the shopping server 12.

In addition, for example, an electronic book that is specified based on the result of questionnaires performed on the user in advance may be specified as the recommended electronic book. Further, for example, an electronic book of a type that is specified by the user in the questionnaires as the user's favorite type may be specified as the recommended electronic book.

Alternatively, for example, a predetermined number of the electronic books in order from the electronic book having the largest number of sales among users of the same age as the user's age, which is specified based on the age included in the account data 22 of the user terminal 14, may be specified as the recommended electronic books. Further, for example, a predetermined number of the electronic books in order from the electronic book having the largest number of sales among users who live in the neighborhood of the user's address, which is specified based on the address included in the account data 22 of the user terminal 14, may be specified as the recommended electronic books. In this regard, “users of the same age” indicate users in their twenties or thirties, for example. “Predetermined number” is, for example, ten. “Users who live in the neighborhood” indicate users whose addresses are included in the same area as the user's address.

The processing execution unit 34 then executes the activation processing of the user terminal 14 (S107). The processing execution unit 34 also sends the recommended electronic book to the user terminal 14 in parallel with the processing shown in S107 (S108). In this embodiment, the activation processing indicates the processing necessary for initializing the user terminal 14. Here, the necessary processing includes, for example, input of the user's personal information other than data associated with the request for the activation processing received in S102, authentication processing of the user terminal 14, and update processing of the operating system installed in the user terminal 14. In this embodiment, sending the recommended electronic book is finished before the activation processing is finished. As described above, in this embodiment, the recommended electronic book is downloaded to the user terminal 14 during the activation processing, and thus the user can view the recommended electronic book on the user terminal 14 right after the activation processing.

According to this embodiment, when the activation processing is executed, the recommended electronic book is sent to the user terminal 14. As such, content suitable for the user is provided to the user terminal 14 that is confirmed to be used by the user. In this way, it is possible to avoid providing content to the user terminal 14 that is not used. Further, the recommended electronic book suitable for the user is provided, and thus the user is more likely to be interested in reading the recommended electronic book. In this embodiment, the user can view the electronic book suitable for the user right after the activation processing is finished. That is, it is possible to produce a state same as the state in which the electronic book is pre-installed without pre-installing the electronic book in the user terminal 14. Further, in this embodiment, history information of the user is specified based on the card number of the user entered by the user on the activation screen 40. The user can receive content suitable for the user in an unexpected way by only inputting information necessary for the payment and without inputting information on the user's preference, and thus, according to this embodiment, it is expected that the user could be surprised and pleased.

In the example of the processing described above, the activation screen 40 may include a field for entering a user ID. Then, the determining unit 32 may specify the purchase history of the electronic books purchased by the user corresponding to the entered user ID, or the purchase history of the electronic books purchased by the user via the shopping server 12 accessed by the user from the other user terminal 14. Alternatively, the determining unit 32 may specify the purchase history of the paper books or the goods or services other than the electronic book that are purchased by the user corresponding to the entered user ID via the shopping server 12. The determining unit 32 may specify the recommended electronic book for the user based on the specified purchase history.

In the above described example of the processing, in S105 and S106, the history information of the user is specified based on the card number entered by the user on the activation screen 40. The card number is an essential entry on the activation screen 40 of this embodiment. In the above described example of the processing, the usage history of the user can be specified with the card number, and thus the recommended electronic book for the user can be specified at the time of starting the use of the user terminal 14 based on the usage history of the user without a need for the user to enter information on the user's preference.

The present invention is not to be limited to the above described embodiment.

For example, in the processing shown in S105, when the content to be provided is specified based on the result of questionnaires, the activation screen 40 may include the questionnaires. In this case, the result of questionnaires is sent to the shopping server 12 together with the request for the activation processing. As such, the shopping server 12 understands the user's current preference, and on that basis, content suitable for the user can be provided.

The method for specifying content suitable for the user is not limited to the above mentioned method based on the usage history of the user. For example, if the places that the user visited in the past can be specified by GPS or the like, the recommended electronic book may be specified based on the places the user visited in the past. Further, for example, an electronic book including a portion of the names of the visited places in its title may be specified as the recommended electronic book. For example, the recommended electronic book may be specified based on the current position of the user terminal 14. For example, when the current position of the user terminal 14 is located in Japan, an electronic book written in Japanese language may be specified as the recommended electronic book. For example, an electronic book relating to recent news may be specified as the recommended electronic book.

Further, for example, in the processing shown in S108, the recommended electronic book may be sent to the user terminal 14 in such a way that a part or all of the electronic book cannot be viewed before the payment processing is not executed, and all of the electronic book can be viewed after the payment processing is executed. For example, the recommended electronic book may be sent to the user terminal 14 in such a way that only the first episode can be viewed before the payment processing, and all of the story can be viewed after the payment processing. In this way, a part of the recommended electronic book suitable for the user can be viewed before the payment processing, and thus it is expected that the user is more likely to purchase the recommended electronic book.

Here, various techniques can be used for restricting viewing of a part or all of the recommended electronic book, or changing the state in which the recommended electronic book cannot be viewed to the state in which the recommended electronic book can be viewed. An encrypted recommended electronic book may be sent from the shopping server 12 to the user terminal 14 together with a decryption key before the payment processing, and decrypted by the decryption key after the payment processing. Alternatively, for example, the encrypted recommended electronic book may be sent from the shopping server 12 to the user terminal 14 before the payment processing, and a decryption key may be sent to the user terminal 14 after the payment processing in order to decrypt the recommended electronic book.

Further, for example, the recommended electronic book may be sent from the shopping server 12 to the user terminal 14 in such a way that bit sequences constituting the recommended electronic book are misaligned before the payment processing, and the bit sequences may be returned to be aligned after the payment processing. Alternatively, for example, the recommended electronic book may be displayed with being masked except a portion thereof before the payment processing, and the mask may be removed after the payment processing.

In this regard, known various DRM (Digital Rights Management) techniques can be used for restricting viewing of a part or all of the recommended electronic book, or changing the state in which the recommended electronic book cannot be viewed to the state in which the recommended electronic book can be viewed.

Further, for example, only a first volume of a multi-volume electronic book may be sent from the shopping server 12 to the user terminal 14 as the recommended electronic book. In this way, the first volume of the multi-volume electronic book suitable for the user is provided to the user as the recommended electronic book, and thus it is expected that the user is more likely to purchase a second volume and later volumes of the multi-volume electronic book.

Further, sending the recommended electronic book to the user terminal 14 is not limited to a case where the shopping server 12 accepts an access requesting the activation processing itself. For example, when an access relating to the activation processing is accepted, the recommended electronic book may be sent to the user terminal 14 while the activation processing of the user terminal 14 is executed. Further, for example, when an access necessary for activating the user terminal 14 in association with the request for the activation processing is accepted, the recommended electronic book may be sent to the user terminal 14 while the activation processing of the user terminal 14 is executed. Further, for example, the shopping server 12 may accept, from the user terminal 14, an access requesting for updating processing of the operating system installed in the user terminal 14. In this case, the shopping server 12 may update the operating system installed in the user terminal 14 and also send the recommended electronic book to the user terminal 14.

Further, for example, the determining unit 32 may specify a length of a period from the previous access to this time access, respectively from the user terminal 14 to the shopping server 12, based on the access history of the user terminal 14 to the shopping server 12. Here, the determining unit 32 may specify such length of period as being infinite when the access is not made. The determining unit 32 then may determine whether or not to send the recommended electronic book to the user terminal 14 based on the length of the period specified as described above. For example, when it is determined that a length of a period from the previous access to this time access, respectively from the user terminal 14 to the shopping server 12, is longer than a predetermined length, the shopping server 12 may send the recommended electronic book to the user terminal 14. Further, for example, when it is determined that the access accepted from the user terminal 14 is the first access, the recommended electronic book may be sent to the user terminal 14. That is, for example, when it is determined that the user terminal 14 has never accessed the shopping server 12, such as a case that the length of the period is determined as being infinite as mentioned above, the recommended electronic book may be sent to the user terminal 14.

According to the embodiment described above, it is possible to prevent content pre-installed in a user terminal 14 from being wasted because the user terminal 14 is not used. Further, according to the embodiment described above, it is possible to prevent content provided to a user terminal 14 from being wasted because the content does not appeal to the user's preference. Further, according to the embodiment described above, since the shopping server 12 provides a user with an electronic book suitable for the user, it is highly likely that a user who starts using a user terminal 14 or a user who uses a user terminal 14 after a long interval is interested in the provided content. In this case, the user is moved to use the user terminal 14 more frequently, and thus the user terminal 14 becomes more useful to the user. This applies to a case in which, when it is determined that an access relating to the activation processing is accepted from a user terminal 14, a recommended electronic book is sent to the user terminal 14. In addition, this applies to a case in which, when it is determined that a first access from a user terminal 14 is accepted, that is, the user terminal 14 has so far never accessed the shopping server 12, a recommended electronic book is sent to the user terminal 14. In addition, this applies to a case in which, when it is determined that a length of a period from the previous access to this time access, respectively from the user terminal 14 to the shopping server 12, is longer than a predetermined length, a recommended electronic book is sent from the shopping server 12 to the user terminal 14. That is, the technical meaning is common to the above described cases, and similar technical advantage is provided in each of the above described cases.

The above describes controlling of sending the electronic book from the shopping server 12 to the user terminal 14 performed in the shopping server 12. Similarly, for example, sending content other than an electronic book, such as music, motion image, game, and various programs, from the shopping server 12 to the user terminal 14 may be controlled by the shopping server 12.

Further, a size of an area reserved for storing content such as an electronic book may be defined in advance. This area is hereinafter referred to as “storage area”. When a value of the unused capacity of the storage area exceeds the predetermined value, the content may be sent to the user terminal 14. In this way, the unused capacity of the storage area of the user terminal 14 can be reserved.

Further, for example, when the user is billed based on a time taken for communications between the user terminal 14 and the shopping server 12, or when content sent from the shopping server 12 to the user terminal 14 is to be charged on an as-used basis, the content may not be sent to the user terminal 14. In this way, it is possible to prevent the user from being charged of the content that the user does not request for.

The roles separately played by the shopping server 12 and the user terminal 14 in this embodiment are not limited to those of the above-mentioned embodiments. Moreover, the specific numerical values and character strings in the specification, and specific numerical values and character strings in the accompanying drawings are exemplary, and the present invention is not limited to those numerical values and character strings.

The invention claimed is:

1. A content providing device comprising:
an accepting unit for accepting an access from an information processing terminal of a user;
a determining unit for determining whether or not to provide the information processing terminal with content suitable for the user based on a length of a period from a previous access of the information processing terminal of the user to this access of the information processing terminal of the user; and
a processing execution unit for executing, in a case where it is determined to provide the information processing terminal with the content suitable for the user, processing for providing the information processing terminal with the content.

2. The content providing device according to claim 1,
wherein the determining unit determines to provide the information processing terminal with the content suitable for the user in a case where an access accepted from the information processing terminal is a first access, and
wherein, in a case where it is determined to provide the information processing terminal with the content suitable for the user, the processing execution unit executes processing for activating the information processing terminal and processing for providing the information processing terminal with the content suitable for the user.

3. A content providing device comprising:
an accepting unit for accepting an access from an information processing terminal of a user;
a determining unit for determining to provide the information processing terminal with content suitable for the user in a case where the access is an access relating to processing for activating the information processing terminal; and
a processing execution unit for executing, in a case where it is determined to provide the information processing terminal with the content suitable for the user, the processing for activating the information processing terminal and processing for providing the information processing terminal of the user with the content suitable for the user.

4. The content providing device according to claim 2,
wherein the accepting unit receives payment information necessary for payment of the content, and
wherein the processing execution unit executes the processing for activating the information processing terminal with use of the payment information, and processing for providing the information processing terminal with the content corresponding to usage history of a shopping system, in which information of the user who is specified based on the payment information is registered, or usage history of the content providing device by the user.

5. The content providing device according to claim 3,
wherein the determining unit determines to provide the information processing terminal with the content suitable for the user in a case where the access is an access for requesting to update an operating system installed in the information processing terminal, and
wherein, in a case where it is determined to provide the information processing terminal with the content suitable for the user, the processing execution unit executes processing for updating the operating system installed in the information processing terminal and processing for providing the information processing terminal with the content suitable for the user.

6. The content providing device according to claim 1,
wherein the determining unit determines to provide the information processing terminal with the content suitable for the user in a case where the length of the period from the previous access of the information processing terminal of the user to this access of the information processing terminal of the user exceeds a predetermined length.

7. The content providing device according to claim 1,
wherein the processing execution unit executes the processing for providing the information processing terminal with the content in a state in which viewing of at least a part of the content is restricted before payment processing of the content is executed, and viewing of the at least a part of the content is allowed after the payment processing of the content is executed.

8. The content providing device according to claim 1,
wherein the determining unit determines whether or not to provide the content based on an unused capacity of a storage unit provided to the information processing terminal.

9. The content providing device according to claim 1,
wherein the determining unit determines not to provide the content to the information processing terminal in a case where communication between the content providing device and the information processing terminal or the content to be provided to the information processing terminal is charged on an as-used basis.

10. A content providing method comprising:
accepting an access from an information processing terminal of a user;
determining whether or not to provide the information processing terminal with content suitable for the user based on a length of a period from a previous access of the information processing terminal of the user to this access of the information processing terminal of the user; and
executing, in a case where it is determined to provide the information processing terminal with the content suitable for the user, processing for providing the information processing terminal with the content.

11. A content providing method comprising:
accepting an access from an information processing terminal of a user;
determining to provide the information processing terminal with content suitable for the user in a case where the access is an access relating to processing for activating the information processing terminal; and
executing, in a case where it is determined to provide the information processing terminal with the content suitable for the user, the processing for activating the information processing terminal and processing for providing the information processing terminal of the user with the content suitable for the user.

12. (canceled)

13. (canceled)

14. (canceled)

15. (canceled)

16. The content providing device according to claim 3,
wherein the accepting unit receives payment information necessary for payment of the content, and
wherein the processing execution unit executes the processing for activating the information processing terminal with use of the payment information, and processing for providing the information processing terminal with the content corresponding to usage history of a shopping system, in which information of the user who is specified based on the payment information is registered, or usage history of the content providing device by the user.
